(19) United States
(12) Patent Application Publication
(10) Pub. No.: US 2024/0370326 A1
(43) Pub. Date: Nov. 7, 2024

(54) Method and device for substituting a plurality of service providers with one service provider

(71) Applicant: ORANGE, Issy-les-Moulineaux (FR)

(72) Inventors: Xavier Marjou, CHATILLON CEDEX (FR); Benoit Radier, CHATILLON CEDEX (FR); Tangui Le Gleau, CHATILLON CEDEX (FR)

(21) Appl. No.: 18/689,567

(22) PCT Filed: Sep. 1, 2022
(86) PCT No.: PCT/FR2022/051647

§ 371 Date: Mar. 6, 2024

(30) Foreign Application Priority Data
Sep. 6, 2021 (FR) 2109297

(51) Int. Cl. G06F 9/54; G06F 9/50

(52) U.S. Cl. CPC G06F 9/546; G06F 9/505

(57) ABSTRACT

A method for substituting a plurality of service providers with one service provider of the plurality for the purpose of routing communication data. The method includes: sending, to each management entity, an information message including an identifier of the active service provider and a parameter regarding interaction between each service provider; at least one instance of receiving, from each management entity, a request message including the interaction parameter updated based on the information message or on the notification message that is received; and at least one instance of sending, to each management entity, a notification message including an identifier of the determined active service provider, and a remuneration value for the service provider.

### 1. TECHNICAL FIELD

The invention relates to reducing the energy consumption required in order to route communication data for a set of clients by benefiting from a collaboration between separate service providers. The method thus meets the requirement of the respective clients of the collaborating service providers to access services, while reducing the energy cost associated with the provision of the access service.

### 2. PRIOR ART

The energy consumption of communications infrastructures is of increasing interest to the service providers responsible for these infrastructures, not only in order to reduce the cost associated with the energy resources to be devoted to activating the infrastructures and to routing client data, but also in order to reduce the resources needed in order to satisfy the clients and thereby preserve our ecosystem. Service providers are also constrained by the respective legislators of the countries in which the service providers deploy and administer communication networks with the target of reducing energy consumption in accordance with an established schedule, thus participating in a more global target of the countries for reducing their energy consumption. Throughout the remainder of the description, a service provider equally can be a communication network operator, with the network being able to be of the public or private type. The communications services relate to digital services and can be linked to services for general public consumers or for businesses on fixed networks or on mobile networks.

It should be noted that the techniques for reducing this consumption are most often implemented in mobile networks, on the one hand, because the traffic on these networks is increasing significantly and the impact of new techniques will be all the more important and, on the other hand, due to the architecture of these mobile access networks requiring antennas and routing equipment that are more spread out over a territory, increasing the associated deployment and activation costs. Furthermore, since in most cases the service providers have deployed their own architectures in order to provide a geographical coverage for their respective clients and for a given area or territory, then as many associated mobile network architectures need to be considered. The deployed networks in most cases are dimensioned in order to route data during a high traffic period and so that, moreover, for a given geographical area, several network architectures are present. The various networks of service providers therefore have resources that are routinely under-used, notably during a period with less traffic, for example, at night, but which individually require energy resources.

Thus, the service providers autonomously implement various solutions in order to reduce their own energy consumption, by collaborating with network equipment providers in order to reduce the energy consumption of said equipment. It is also possible to place some equipment on stand-by, or even to place some functions on stand-by when they are not necessary, by using virtualized functions that are possibly deployed and activated as a function of requirements, reducing the cost associated with routing data in a network.

More specifically, according to the techniques that are currently used, if a mobile telephone service provider (MNO) wishes to limit the energy consumption of their mobile network, they can turn off certain frequency bands (for example, 2,600 MHz and 1,800 MHz band), but they must keep at least one active in order to provide connectivity for the few users requiring nighttime connectivity (for example, the 800 MHz band that covers the greatest surface area around access stations). An MNO can also reduce the bandwidth that it allocates to its users and/or turn off virtual equipment as a function of the requirements of the clients. In the same way, stakeholders/service providers that share a shared infrastructure can turn off the equipment that is not necessary for their requirements or for their clients.

These solutions effectively meet the targets and the commitments for reducing the consumption of energy resources, but one or more alternative or additional solutions needs to be contemplated in order to significantly meet the ever increasing targets and commitments for reducing consumption.

The aim of the present invention is to provide improvements in relation to the prior art.

### 3. DISCLOSURE OF THE INVENTION

The invention improves the situation using a method for substituting a plurality of service providers with one service provider, called active service provider, of the plurality of service providers for the purpose of routing communication data, the method being implemented in a mediation entity able to communicate with a management entity implemented by each service provider of the plurality of service providers and comprising:
sending each management entity an information message comprising an identifier of the active service provider and an interaction parameter between each of the service providers of the plurality of service providers, and, as long as a received state value does not indicate an end of negotiation:
at least one reception step for receiving a request message from each management entity comprising an identifier of the service provider whose management entity sends the message and the interaction parameter updated as a function of the received information message or notification message;
at least one sending step for sending each management entity a notification message comprising an identifier of the determined active service provider, the interaction parameter between each of the service providers updated as a function of the received request messages, a remuneration value of the service provider receiving the notification message, and the state value updated as a function of the interaction parameter of the notification message.

The substitution method is advantageous as it allows one service provider to route the communication data for one or more communication services, instead of a plurality of service providers. Thus, the method means that the service providers no longer have to route data and can thus turn off their networks or can place them on stand-by and thus save resources, notably energy resources. The substitution method is commendable since the active service provider responsible for routing the data changes over time and allows the various service providers of the plurality of service providers to become an active service provider so that each service provider of the plurality of service providers can save resources when it is not active. The substitution method notably can be implemented for a determined duration, for example, when less traffic is to be routed, provided that the active service provider has the capabilities necessary to route the data that is normally routed by a plurality of service providers. Thus, by virtue of remuneration values associated with the active or non-active role of a service provider, it is possible for the mediation entity to determine, for a subsequent duration, a service provider, from among the plurality of service providers, that is to become active as a function of the remuneration and therefore of its contribution to routing over previous periods. Therefore, the substitution method is advantageous since each service provider is encouraged to participate and to become active on a regular basis, in exchange for the possibility of becoming non-active and of saving resources at other times. The mediation entity makes it possible for the service providers contributing to the substitution method not to exchange data directly. The mediation entity can thus guarantee the authenticity of the request messages, but also the confidentiality of the information sent in the request message, and notably the interaction parameter sent by the service providers. This interaction parameter is used by the mediation entity to ensure that each service provider positively contributes to the method by properly providing the active service provider function and to identify a service provider that would only make substitution requests, in which case this operator will be encouraged by the mediation entity to become an active operator during a subsequent cycle, namely a cycle corresponding to a number of messages exchanged between the transmission of two successive information messages. A new sent information message comprises the identifier of the active service provider identified by the mediation entity following the implementation of the method during the previous cycle. The successive cycles, during which a service provider, for example, one that has saved the least amount of resources for the other service providers, is selected as the active operator, are not necessarily contiguous and can be executed, for example, at a certain time of day, for example, from midnight to six in the morning each day.

According to one aspect of the invention, in the substitution method, the interaction parameter between each service provider comprises a parameter requesting the substitution of one service provider of the plurality of service providers for each of the other service providers of the plurality of service providers, and a parameter offering the substitution of one service provider of the plurality of service providers for each of the other service providers of the plurality of service providers.

The interaction parameter is advantageously structured as a substitution request sent by a management entity of a service provider of the plurality of service providers and a substitution offer allowing a service provider to propose itself as an active service provider, for example, upon receipt of an information message notifying it that it has been determined as an active service provider for the next cycle. Thus, a service provider can make a request to another service provider, via this information, to route its data or even propose routing their data to other service providers, for example, for a cycle duration.

According to one aspect of the invention, in the substitution method, updating the interaction parameter as a function of the received request messages comprises configuring, in the notification message sent to the management entity of the active service provider, the substitution requests received in the request messages sent by the non-active service providers of the plurality of service providers.

Since the substitution method is not based on direct exchanges of messages, i.e., without an intermediary, between the management entities of the respective service providers of the plurality of service providers contributing to the substitution method, the aim of the mediation entity is, on the one hand, to share the offers and requests from one service provider to the other service providers, to process these offers and requests and also to ensure that the various service providers effectively contribute to the substitution method by checking the received messages. If applicable, the mediation entity can place a service provider on a blacklist by modifying the interaction parameter as a function of the received messages.

According to another aspect of the invention, in the substitution method, the updated interaction parameter of the request message further comprises a datum relating to the technology of a communication network of the service provider whose management entity sends the request message.

The interaction parameter of the request messages advantageously can be modified to include information relating to the technology used by the service provider to transmit the data. The datum relating to the technology equally can be a datum relating to the type of network that is operated, for example, of the 2G, 3G, 4G or 5G type, and/or a frequency band used by the service provider, and/or information relating to the bandwidth used by a service provider for routing data. The mediation entity, and finally the active service provider, takes into account this information in order to respectively select an active service provider and route the data using the technology used by the service provider wishing to be substituted via the interaction parameter.

According to another aspect of the invention, in the substitution method, the notification message further comprises information indicating whether the service provider whose management entity receives the notification message is removed from the plurality of service providers when implementing the substitution method.

The substitution method is commendable if the various service providers contribute to the method by being designated during some cycles as an active service provider and by offering their availability to route the data of other service providers by updating the interaction parameter. For example, if a management entity does not offer substitution to other service providers even though it is indicated as an active service provider in an information message or if a service provider has not indicated a correct consumed resource that corresponds to routing data of the service providers of the plurality of service providers, then it can be removed from the plurality of service providers for one or more cycles, thus preventing it from having its traffic routed by another service provider for a period of time. The service providers contributing to the method, knowing that one of the service providers has been removed from the plurality of service providers via the information in the notification message, know that they must route data more frequently.

According to another aspect of the invention, in the substitution method, the notification message further comprises a datum related to the consumption of resources saved by substituting the service providers of the plurality of service providers with the active service provider.

The substitution method is designed so that the service providers contributing to the method experience a balanced consumption of resources for routing data over a set of cycles. This datum relating to the consumption of resources can be the resource saved for the non-active service providers and the resource consumed for the active service provider. Thus, each management entity can be notified of the estimated savings or expenditure involved in implementing the method and can individually ensure that the method does not provide one service provider with an advantage over another. This datum also allows the estimated value to be compared with the computed value and, if applicable, allows the mediation entity, or even an entity registering the difference, to be notified so that the determination of an active service provider during a subsequent cycle takes this into account.

According to another aspect of the invention, in the substitution method, the state value indicates an end of negotiation if the interaction parameter of the request message sent by the active service provider comprises a substitution offer parameter or if the number of request and/or notification messages reaches a predetermined value.

The mediation entity sets the state value, such as a binary element, when one of the service providers of the plurality of service providers is in a position to route the data instead of the service providers of the plurality of service providers, for example, for a given period. This can notably occur when the active service provider is able to favorably respond to the substitution requests requested by the other service providers. The state value can also indicate when a number of request and notification messages reaches a predefined value, indicating that no substitution agreement has been able to be established. Once the state value indicates an end of negotiation, the service provider networks, using roaming techniques, for example, can be configured so that the data routing that is normally carried out by the plurality of service providers is carried out by the active service provider.

According to another aspect of the invention, in the substitution method, the remuneration value relates to the savings in resources generated by the recipient service provider.

As the substitution method is designed so that service providers of the plurality of service providers route the data of the plurality of service providers while guaranteeing a balance in terms of the resources used for successive routing by the active service providers, the service provider of the plurality of service providers that is selected to route data is the service provider with the lowest contribution to saving resources of the other service providers. The remuneration value, for example, which is accumulated over a set of substitution cycles, indicating the savings in resources generated by a service provider, advantageously can be used for determining the active operator. The closer the value is to 0, the fewer resources the service provider will have to consume, meaning that it will be more likely to be determined as the active service provider during one of the following substitutions.

According to another aspect of the invention, in the substitution method, a new active service provider is also determined as a function of the transmitted remuneration values and/or as a function of a resource consumed by the active service provider for routing communication data as a substitute for the service providers of the plurality of service providers.

The active service provider can be determined by benefiting from information relating to the resources consumed for routing data when it carries out the routing instead of the other service providers or even as a function of the remuneration values issued by the mediation entity or even by using the two parameters. The information relating to the resources that are actually consumed allows, for example, the differences to be corrected between the estimated consumption values and the consumed values, with this consumed resources value being able to be obtained from a registration entity, such as a server using DLT (Distributed Ledger Technology) technology. The remuneration value ensures that each service provider contributes to the method in a balanced manner, by ensuring a fair distribution of the contribution of each provider of the plurality of providers.

The various aspects of the substitution method described above can be implemented independently of one another or in combination with one another.

The invention also relates to a method for determining an active service provider from among a plurality of service providers for the purpose of routing communication data, the method being implemented by a management entity of each service provider of the plurality of service providers able to communicate with a mediation entity and comprising:
receiving an information message from the mediation entity comprising an identifier of the active service provider and an interaction parameter between each service provider of the plurality of service providers, and, as long as a received state value does not indicate an end of negotiation:
at least one updating step for updating the interaction parameter as a function of the received information message or notification message;
at least one sending step for sending the mediation entity a request message comprising an identifier of the service provider whose management entity sends the message and the updated interaction parameter;
at least one reception step for receiving a notification message from the mediation entity comprising an identifier of the determined active service provider, the interaction parameter between each of the service providers updated as a function of the received request messages, a remuneration value of the service provider receiving the notification message, and the state value updated as a function of the interaction parameter of the notification message.

According to one aspect of the invention, in the determination method, updating the interaction parameter in the request messages comprises updating a parameter requesting the substitution of a non-active service provider of the plurality of service providers for the active service provider as a function of the identifier of the active service provider received in the notification message or the offer for substitution by the active service provider to the non-active service providers as a function of the request parameters received in the notification messages.

Updating the interaction parameter by the respective entities contributing to the method allows the information to be shared without direct exchanges between the management entities and also allows the mediation entity to be able to control the requests and the offers, notably to ensure that there is a balance in terms of the resources consumed by the various service providers.

According to one aspect of the invention, the determination method further comprises the active service provider sending a registration entity a resource consumed for routing the communication data in substitution for the service providers of the plurality of service providers.

Without sending the consumed resource, the method is based on estimates, notably via the datum relating to the consumption possibly sent to the management entities. The consumed resource sent to the registration entity is intended to effectively control the consumption of each service provider during successive substitutions and therefore is intended to improve the process of determining the next active service provider from among the plurality of service providers.

The various aspects of the determination method described above can be implemented independently of one another or in combination with one another.

The invention also relates to a device for substituting a plurality of service providers with one service provider, called active service provider, of the plurality of service providers for the purpose of routing communication data, the device being implemented in a mediation entity able to communicate with a management entity implemented by each service provider of the plurality of service providers and comprising:
a transmitter,
able to send an information message to each management entity comprising an identifier of the active service provider and an interaction parameter between each service provider of the plurality of service providers; and
able to send, as long as a received state value does not indicate an end of negotiation, each management entity a notification message comprising an identifier of the determined active service provider, the interaction parameter between each of the service providers updated as a function of the received request messages, a remuneration value of the service provider receiving the notification message, and the state value updated as a function of the interaction parameter of the notification message;
a receiver, able to receive, as long as the received state value does not indicate an end of negotiation, a request message from each management entity comprising an identifier of the service provider whose management entity sends the message and the interaction parameter updated as a function of the received information message or notification message;
a computer, able to update the state value as a function of the interaction parameter of the notification message.

This device is able to implement the substitution method described above in all the embodiments thereof.

The invention also relates to a device for determining an active service provider from among a plurality of service providers for the purpose of routing communication data, the device being implemented in a management entity of each service provider of the plurality of service providers that is able to communicate with a mediation entity and comprising:
a receiver,
able to receive an information message from the mediation entity comprising an identifier of the active service provider and an interaction parameter between each service provider of the plurality of service providers, and, as long as a state value does not indicate an end of negotiation:
able to receive at least one notification message from the mediation entity comprising an identifier of the determined active service provider, the interaction parameter between each of the service providers updated as a function of the received request messages, a remuneration value of the service provider receiving the notification message, and the state value updated as a function of the interaction parameter of the notification message;
a computer, able to update the interaction parameter as a function of the received information message or notification message;
a transmitter, able to send the mediation entity at least one request message comprising an identifier of the service provider whose management entity sends the request message and the updated interaction parameter.

This device is able to implement the determination method described above in all the embodiments thereof.

The invention also relates to a system for substituting a plurality of service providers with one service provider, called active service provider, of the plurality of service providers for the purpose of routing communication data, said system comprising:
a mediation entity comprising a substitution device;
at least two service providers each comprising a management entity comprising a determination device.

The invention also relates to computer programs comprising instructions for implementing the steps of the respective substitution and determination methods described above, when these programs are both executed by a processor and a storage medium that can be respectively read by a substitution and determination device on which the computer programs are stored.

The aforementioned programs can use any programming language and can be in the form of source code, object code or of intermediate code between source code and object code, such as in a partially compiled format or in any other desirable format.

The aforementioned information media can be any entity or device capable of storing the program. For example, a medium can comprise a storage means, such as a ROM, for example, a CD-ROM or a microelectronic circuit ROM, or even a magnetic recording means.

Such a storage means can be, for example, a hard disk, a flash memory, etc.

Moreover, an information medium can be a transmissible medium such as an electrical or optical signal, which can be routed via an electrical or optical cable, via radio or via other means. A program according to the invention particularly can be downloaded over a network of the Internet type.

Alternatively, an information medium can be an integrated circuit, in which a program is incorporated, with the circuit being adapted to execute or to be used to execute the methods in question.

### 4. BRIEF DESCRIPTION OF THE DRAWINGS

Further features and advantages of the invention will become more clearly apparent upon reading the following description of particular embodiments, which are provided by way of simple illustrative and non-limiting examples, and from the appended drawings, in which:

FIG. 1 shows a simplified view of a diagram showing an advantage of the substitution method and of the determination method according to one aspect of the invention;

FIG. 2 shows a simplified view of an architecture in which the substitution method and the determination method are implemented according to another aspect of the invention;

FIG. 3 shows a simplified view of a substitution method and of a determination method according to another aspect of the invention;

FIG. 4 shows a substitution device according to one embodiment of the invention;

FIG. 5 shows a determination device according to one embodiment of the invention.

### 5. DESCRIPTION OF THE EMBODIMENTS

Throughout the remainder of the description, embodiments of the invention are described in a communication architecture. This infrastructure can be implemented in order to route communications data from a plurality of service providers, therefore at least two, to fixed or mobile terminals, knowing that one of the aims of the substitution method and of the determination method is to be able to route the communication data normally routed by all the service providers using a limited number of service providers, notably so as to reduce the resources, notably the energy resources, consumed for routing data.

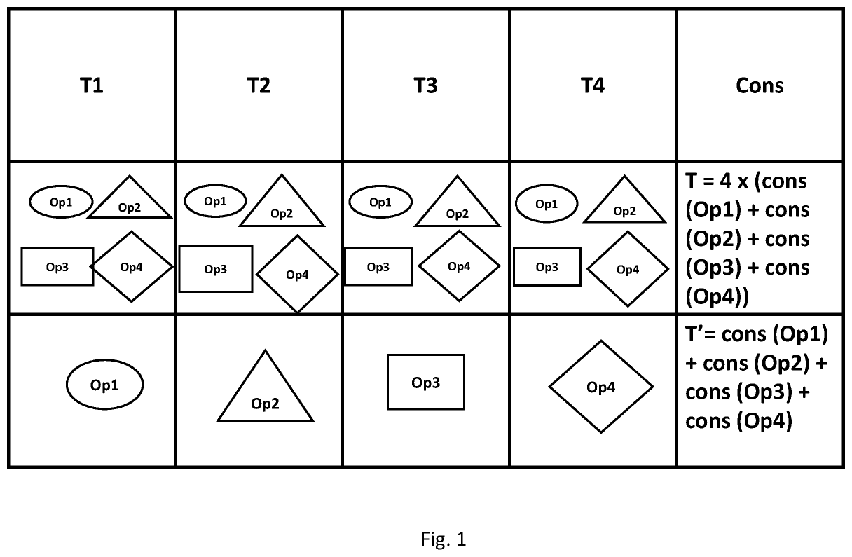

Firstly, reference is made to FIG. 1, which shows a simplified view of a diagram showing an advantage of the substitution method and of the determination method according to one aspect of the invention.

This diagram shows four time intervals T1, T2, T3, T4, which are, for example, durations during which the substitution method is implemented. This can involve time intervals for one day, for one week or for another period. According to one example, this can involve time intervals during which service provider networks are used less, typically from midnight to six in the morning.

This diagram also shows four service providers Op1, Op2, Op3 and Op4, which are, according to this example, mobile network service providers providing a communication data access and routing service for their respective clients. The 4 service providers Op1, Op2, Op3 and Op4 are considered to operate networks that each have a comparable geographical footprint and each service provider is considered to be able to provide access to and to route the data received and transmitted by the other three service providers. In this case, the routing service is also considered to include the service for accessing a communication network. According to this example, each service provider Op1, Op2, Op3 and Op4 is also considered to have a network capable of routing the data from the clients of the other service providers, which in this case is made possible by the fact that the intervals T1, T2, T3 and T4 are periods during which the communications networks are used less and that one network is sufficient for routing the client data normally routed by the four service providers Op1, Op2, Op3 and Op4. In a separate period of the intervals T1, T2, T3, T4, the data are actually routed by the 4 service providers Op1, Op2, Op3 and Op4.

During the time interval T1, via the implementation of the substitution method and of the determination method, the service provider Op1 acts as a substitute for the service providers Op1, Op2, Op3 and Op4 for routing the data from these service providers. Thus, during the time interval T1, only the service provider Op1 activates its frequency bands and the network equipment in order to provide the connectivity service and to route the data of the clients of the four service providers Op1, Op2, Op3 and Op4, which means that the other 3 service providers Op2, Op3, Op4 can stop activating their own frequency bands and network equipment, allowing them to be able to save resources, notably energy resources, but also the resources associated with managing the respective networks placed on stand-by during this interval T1. The resources also can be gigabytes since a service provider acting as substitute for the other service providers transmits gigabytes of data instead of other service providers. The techniques used by the service provider Op1 responsible for routing the data of the clients of the four service providers equally can be based on roaming techniques or even on access sharing (RAN sharing) techniques. At least one service provider must route the data during a period of time knowing that, when demanded, i.e., due to high traffic, two service providers could route the data of the four service providers.

During the time interval T2, another service provider of the plurality of service providers provides the communication data routing service on behalf of the four service providers Op1, Op2, Op3 and Op4. The substitution method relies on the contribution of each service provider of the plurality of service providers to routing the data of all the service providers during a given time interval. Thus, during the interval T2, Op2 routes the data instead of the four service providers Op1, Op2, Op3 and Op4. In the same way, during the interval T3, the service provider Op3 routes the data as a substitute for the four service providers Op1, Op2, Op3 and Op4, and during the interval T4, the service provider Op4 provides the routing service. As the aim is that each service provider equally contributes to the substitution method, in the case whereby each service provider theoretically consumes the same amount of resources during the different intervals, a cyclic turnaround of the service providers can be implemented for routing the data. However, the service providers do not necessarily consume the same level of resources, and therefore the operators do not save the same amount of resources for the other service providers during the various time intervals of a cycle, with the cycle being able to correspond to a period during which a service provider has been substituted for the other service providers at least once. According to one example, the service provider that saved the least amount of resources for the other service providers, during a cycle or during an accumulation of several cycles, is responsible for routing during the next interval. For example, in a configuration with two MNOs (Mobile Network Operators) (MNO-A and MNO-B) where the network of the MNO-A consumes 40 KWH and that of the MNO-B consumes only 20 kWh, at this moment, in the event that the substitution is activated at night, the mediation entity EM will ensure that MNO-A is set to active for 2 nights in 3 and that MNO-B is set to active for 1 night in 3. Thus, MNO-B is not impaired since, when MNO-B is active, it saves MNO-A 40 kWH, whereas when MNO-A is active, it saves MNO-B only 20 kWH.

According to the diagram of FIG. 1, in the event that each service provider Op1, Op2, Op3 and Op4 consumes the same amount of resources during each interval T1, T2, T3, T4, the consumption Cons of resources during the 4 intervals T1, T2, T3, T4 is equivalent to the sum of the resource consumptions of each service provider instead of four times the sum of the resource consumptions of each service provider. According to this simplified example, the resources have been divided by four for routing the same amount of data. It should be noted that this comparison results from a highly simplified estimate whereby the cost to a service provider for routing data does not only result from routing the data itself, but also from a residual cost of activating networks and management independent of the data routing. Placing three service providers on stand-by during the periods T1, T2, T3 and T4 therefore causes the resources associated with operating three networks from among four to be reduced and even to disappear accordingly.

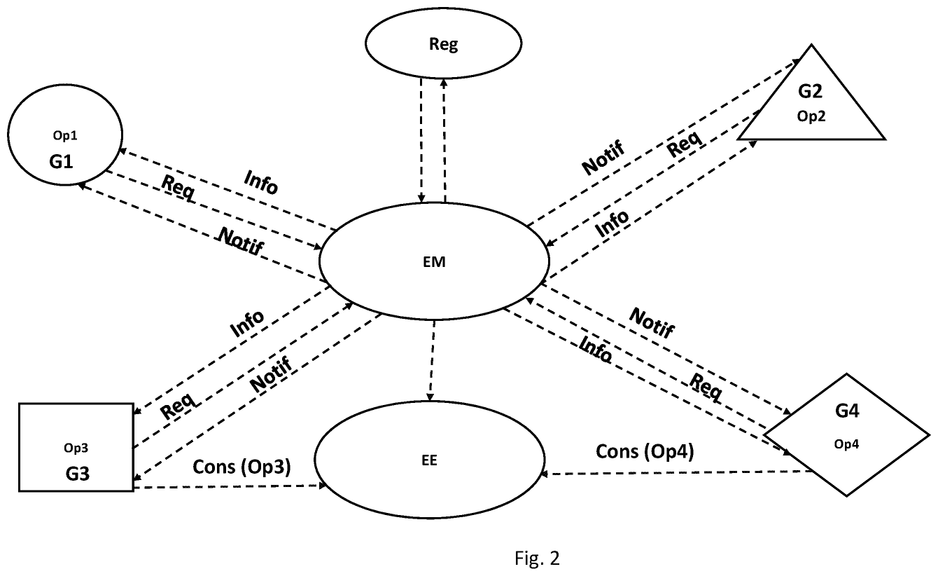

As the substitution method is based on an active contribution from each service provider to the method, implementing a mediation entity to ensure that no service provider is impaired proves to be advantageous, as specified in FIG. 2.

In FIG. 2, the four service providers are operators Op1, Op2, Op3 and Op4, which are also shown. Each operator Op1, Op2, Op3 and Op4 comprises a management entity, respectively G1, G2, G3, G4. According to one example, these management entities are entities G1, G2, G3 and G4 for administering the networks of the operators. These management entities G1, G2, G3, G4 are able to exchange information with a mediation entity EM. According to one example, this mediation entity EM is a collaboration platform managed by a third-party entity, such as a regulator, a resource provider or an entity for administering a geographical plate. According to another example, this mediation entity EM manages the substitution on the basis of the resources consumed by the operators Op1, Op2, Op3 and Op4 for routing communications data. According to an alternative, the mediation entity interacts with a regulation entity Reg. For example, the role of this regulation entity is to select the operators who collaborate with the substitution method, to identify an operator who would not satisfactorily collaborate with the method and, if applicable, to remove it from the method for one or more cycles. The regulating entity can, according to one example, be specific to a geographical area, for example, of a country, or even can be associated with a communication service, particularly in the case whereby the data routed by an operator substituting a plurality of operators relates to a communications service in particular. According to one example, the regulation Reg and mediation entities EM are managed by one and the same entity. According to an alternative, the communication architecture in which the substitution method is implemented further comprises a registration entity EE. For example, this registration entity EE is intended to gather the information relating to data routing when implementing the substitution method. Thus, the actual consumption of resources by an “active” operator, i.e., for routing data instead of other operators for a determined duration, can be registered and, if applicable, compared with a theoretical value initially determined when determining the active operator, for example. According to one example, this registration entity interacts with the management entities G1, G2, G3, G4 of the operators and with the mediation entity EM. This registration entity EE uses, for example, DLT (Distributed Ledger Technology) technology. In the event that the consumed resources are watts-hour, the management entities can transmit the consumed watts-hours when the operators successively route the data and then compare these values with the theoretical values selected to determine an active operator among the plurality of operators, for example. Thus, based on information actually observed and sent by the registration entity EE to the mediation entity EM, said mediation entity can correct any possible errors in order to improve how to determine the selection of an active operator for a subsequent time interval, for example, by using the consumed value accumulated by the various operators during their turns when they successively routed the data. It also should be noted that transparency with respect to the amount of resources that has actually been consumed, when this information is widely available, for example, via the previously mentioned DLT, is an incentive if at least 2 operators collaborate. Indeed, any operators reluctant to collaborate will see, via the publicly shared data, that the operators who collaborate consume less resources than them, by virtue of the time intervals during which they are inactive, and this may encourage the operators not participating in the substitution method to contribute, for example, by registering themselves with the regulation entity Reg.

The substitution method implemented by the mediation entity EM comprises an optional step involving the regulation entity Reg sending a configuration message comprising a set of operators contributing to the substitution method and possibly identifying operators to be removed from the method (blacklisted operators) that should not be retained for one or more cycles. This configuration message can comprise the identifiers of the operators Op1, Op2, Op3, Op4 retained in or to be removed from the method, as well as the information allowing the mediation entity to solicit them, such as the information relating to the management entities G1, G2, G3, G4 of these operators.

The mediation entity sends, for example, following this configuration message, or even autonomously if the mediation entity EM autonomously identifies, by means of a configuration or by soliciting the operators Op1, Op2, Op3, Op4, an information message Info to the management entities G1, G2, G3, G4 of the various operators Op1, Op2, Op3, Op4, notifying them which operator from among the four operators has been selected as an active operator, possibly with an indication relating to the time interval during which the operator is active. This information message Info further comprises an interaction parameter between the various operators Op1, Op2, Op3, Op4, therefore comprising an interaction datum between Op1 and Op2, between Op1 and Op3, between Op1 and Op4, between Op2 and Op3, etc. According to one example, a management entity G1, G2, G3, G4 only receives the interaction data relating to the operator receiving the information message. Thus, the management entity G1 only receives the interaction data relating to the operator Op1. An operator is not only an entity operating a network but also includes the entities providing a service, for example, of the OTT (Over The Top) type.

The management entities G1, G2, G3, G4 that received the information message Info send the management entity EM a request message Req comprising the updated interaction parameter. For example, the operators that received the information relating to the identified active operator can send the mediation entity a request to substitute with the operator identified as active. Thus, if the operator Op1 whose identifier was sent in the information message Info acts as the active operator, the management entities G2, G3, G4 of the operators Op2, Op3, Op4 can send a request to substitute the respective operators Op2, Op3 and Op4 with the operator Op1, with these messages comprising the identifier of the operator Op2, Op3, Op4 making the request.

The mediation entity EM, upon receiving these request messages Req sent by the management entities G1, G2, G3, G4, identifies the various substitution requests, as well as the substitution offers, updates the interaction parameter and uses a notification message Notif to notify the management entities G1, G2, G3 and G4 of the various received requests from the operator or operators who formulated offers. This notification message notably allows the management entities of the operators who have made a substitution offer to become aware of the requests. In the present case, the operator Op1 becomes aware of the requests made by the operators Op2, Op3 and Op4. These notification messages Notif further comprise a remuneration value of each operator in the substitution, indicating, for example, a saved amount of resources or an amount of resources to be consumed by each operator who transmitted a substitution request, with this value also being able to depend on the number of request messages exchanged with the mediation entity, with the aim being to agree on a substitution with a minimum amount of sent request messages. The notification messages Notif further comprise a state value indicating whether the substitution method has been finalized and can be established. This can be a Boolean value indicating whether the method is finalized (value 1) or not (value 0). In the event that the messages include the value of 0, the management entities G1, G2, G3, G4 must send new request messages Req with new interaction parameters, for example, with new offers and requests. The mediation entity EM will transmit notification messages Notif in response by listing the various offers and requests, and by updating the remuneration values, since new messages are exchanged, and by updating the state value. These exchanges of request and notification messages last for as long as the state value does not assume the value of 1, indicating that the method is finalized or even indicating that a number of messages has been reached without it being possible for a substitution agreement or offers corresponding to the requests to be obtained.

In the event that the method is finalized, and that a substitution can be implemented, this substitution occurs via known roaming or RAN sharing techniques or any other technique allowing this substitution, and a new substitution can be implemented, with the mediation entity EM selecting a new active operator, for example, by selecting, from among the operators Op1, Op2, Op3, Op4, the operator who saved the least amount of resources for the other operators in terms of the cumulative value of the various implemented substitution methods, for example, via the remuneration values possibly corrected by the consumption data (shown in FIG. 2) by the information Cons (Op3) and Cons (Op4)) sent by the management entities G1, G2, G3, G4 of the operators Op1, Op2, Op3, Op4 to the registration entity EE that said registration entity can advantageously resend to the mediation entity EM in order to improve the determination of the next active operator.

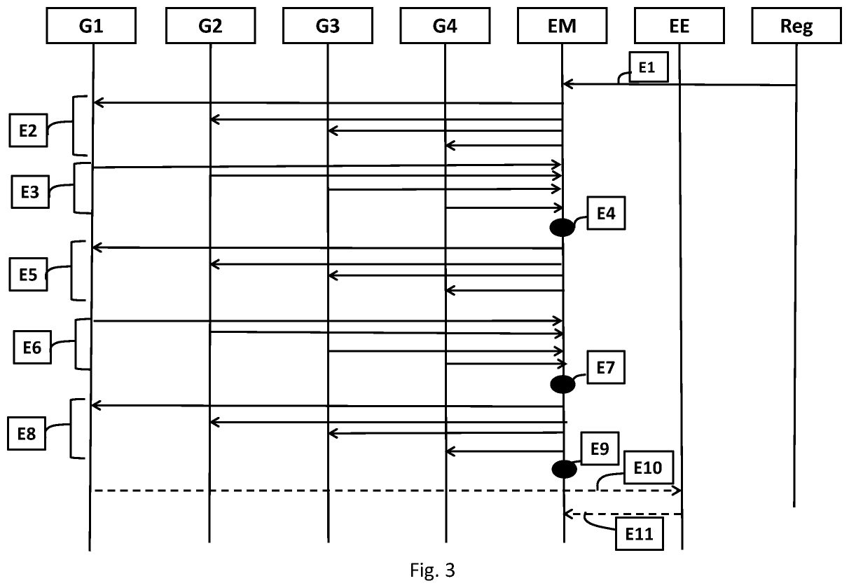

Reference will now be made to FIG. 3, which shows a simplified view of a substitution method and of a determination method according to another aspect of the invention.

FIG. 3 shows the entities G1, G2, G3, G4, EM, EE and Reg that are shown and described in FIG. 2.

During a step E1, the regulation entity Reg sends the mediation entity a message indicating the service providers/operators contributing to the substitution method, and possibly the service providers/operators included on a blacklist for this substitution method.

During a step E2, the entity EM sends the management entities G1, G2, G3 and G4 a notification message, as shown below.

Information message Info sent by the entity EM to G1: Info: [request from Op2 to Op1=0, request from Op3 to Op1=0, request from Op4 to Op1=0, offer from Op2 to Op1=0, offer from Op3 to Op1=0, offer from Op4 to Op1=0, onguard-Op1=1, onguard-Op2=0, onguard-Op3=0, onguard-Op4=0, blacklisted-Op1=0, blacklisted-Op2=0, blacklisted-Op3=0, blacklisted-Op4=0].

Information message Info sent to G2: Info: [request from Op1 to Op2=0, request from Op3 to Op2=0, request from Op4 to Op2=0, offer from Op1 to Op2=0, offer from Op3 to Op2=0, offer from Op4 to Op2=0, onguard-Op1=1, onguard-Op2=0, onguard-Op3=0, onguard-Op4=0, blacklisted-Op1=0, blacklisted-Op2=0, blacklisted-Op3=0, blacklisted Op4=0].

Information message Info sent to G3: Info: [request from Op1 to Op3=0, request from Op2 to Op3=0, request from Op4 to Op3=0, offer from Op1 to Op3=0, offer from Op2 to Op3=0, offer from Op4 to Op3=0, onguard-Op1=1, onguard-Op2=0, onguard-Op3=0, onguard-Op4=0, blacklisted-Op1=0, blacklisted-Op2=0, blacklisted-Op3=0, blacklisted-Op4=0].

Information message Info sent to G4: Info: [request from Op1 to Op4=0, request from Op2 to Op4=0, request from Op3 to Op4=0, offer from Op1 to Op4=0, offer from Op2 to Op4=0, offer from Op3 to Op4=0, onguard-Op1=1, onguard-Op2=0, onguard-Op3=0, onguard-Op4=0, blacklisted-Op1=0, blacklisted-Op2=0, blacklisted-Op3=0, blacklisted-Op4=0].

The information messages Info sent to the management entities G1, G2, G3, G4 of the operators Op1, Op2, Op3, Op4 include request and offer parameters for substituting the respective operators Op1, Op2, Op3, Op4 for each of the other operators Op1, Op2, Op3, Op4 of the plurality of operators. In this example, the operators only receive the substitution parameters, comprising offers and requests from the other operators that do not concern them (the management entity G1 only receives the requests and the offers concerning the operator Op1). The information onguard-Op1=1 present in the information messages Info notifies the management entities that the operator Op1 is determined to be an active operator for the next substitution. According to one example, the information message Info can also include a time datum indicating a time interval during which the substitution takes place.

During a step E3, the management entities G1, G2, G3 and G4, in response to the received information message, send the mediation entity EM a request message Req comprising an identifier of the operator sending the request message and the received updated interaction parameter. Thus, the messages Req sent by the respective management entities are as follows, for example, in the following form:

Request message Req sent by the entity G1 to the entity EM: Action: [request from Op1 to Op2=0, request from Op1 to Op3=0, request from Op1 to Op4=0, offer from Op1 to Op2=0, offer from Op1 to Op3=0, offer from Op1 to Op3=0, agent-id=1].

This request message indicates that the operator Op1 neither requests nor offers any substitution service to the other operators and that the operator Op1, whose identifier is 1, sends this message.

Similarly, the management entities G2, G3, G4 send the following request messages:

Request message Req sent by the entity G2 to the entity EM: Action: [request from Op2 to Op1=1, request from Op2 to Op3=0, request from Op2 to Op4=0, offer from Op2 to Op1=0, offer from Op2 to Op3=0, offer from Op2 to Op4=0, agent-id=2].

Request message Req sent by the entity G1 to the entity EM: Action: [request from Op3 to Op1=1, request from Op3 to Op2=0, request from Op3 to Op4=0, offer from Op3 to Op1=0, offer from Op3 to Op2=0, offer from Op31 to Op4=0, agent-id=3].

Request message Req sent by the entity G1 to the entity EM: Action: [request from Op4 to Op1=1, request from Op4 to Op2=0, request from Op4 to Op3=0, offer from Op4 to Op1=0, offer from Op4 to Op2=0, offer from Op4 to Op3=0, agent-id=4].

In these messages Req, the management entities G2, G3, G4 request the substitution of the operators Op2, Op3, Op4 with the operator Op1 and do not offer any substitution.

In this example, these request messages only include the interactions in which the operator sending the request message intervenes.

According to an alternative, these request messages Req include a datum relating to the technology of the network operated by the operator sending the message. A management entity G1, G2, G3 and G4 can therefore update the interaction parameter received in the information message with this datum. This datum can indicate, for example, the version of the cellular network operated by the operator (2G, 3G, 4G, 5G, etc.), and/or indicate the frequency band used by the operator for granting clients access to its network and/or can include information relating to the bandwidth used for routing the communication data.

The use of substitution request actions and substitution offers thus allows each operator to choose whether or not to collaborate, independently of the information concerning the active operator sent by the mediation entity.

Upon receiving the request messages, during a step E4, the mediation entity EM extracts the interaction parameters, processes them and configures, in the notification messages to be sent, the interaction parameters as a function of the requests and offers of the various operators.

The mediation entity EM then sends, during step E5, the management entities of the operators contributing to the substitution method the notification messages comprising the interaction parameters configured during step E4. The notification messages sent to the management entities G1, G2, G3, G4 are, according to an alternative, as shown below.

Notification message Notif sent by the entity EM to G1: Observation: [request from Op2 to Op1=1, request from Op3 to Op1=1, request from Op4 to Op1=1, offer from Op2 to Op1=0, offer from Op3 to Op1=0, offer from Op4 to Op1=0, onguard-Op1=1, onguard-Op2=0, onguard-Op3=0, onguard-Op4=0, blacklisted-Op1=0, blacklisted-Op2=0, blacklisted-Op3=0, blacklisted-Op4=0, rec=−0.01, end=0].

The mediation entity EM thus indicates, via this message Notif, that the operators Op2, Op3 and Op4 have made a request to be substituted with the operator Op1, that no operator has proposed an offer of substitution, that the remuneration value rec is negative (−0.01), because for the time being there is no substitution agreement, and that a message is sent in order to reach this agreement. The purpose of this negative value is to encourage the agent to contribute to the substitution method. The message further comprises a state value (end), in this case set to 0, indicating an ongoing negotiation between the operators for implementing the substitution.

The notification messages Notif sent by the entity EM to the management entities G2, G3, G4 are in the following form:

Notification message Notif sent by the entity EM to G2: Observation: [request from Op1 to Op2=0, request from Op3 to Op2=0, request from Op4 to Op2=0, offer from Op1 to Op2=0, offer from Op3 to Op2=0, offer from Op4 to Op2=0, onguard-Op1=1, onguard-Op2=0, onguard-Op3=0, onguard-Op4=0, blacklisted-Op1=0, blacklisted-Op2=0, blacklisted-Op3=0, blacklisted-Op4=0, rec=−0.01, end=0].

Notification message Notif sent by the entity EM to G3: Observation: [request from Op1 to Op3=0, request from Op2 to Op3=0, request from Op4 to Op3=0, offer from Op1 to Op3=0, offer from Op2 to Op3=0, offer from Op4 to Op3=0, onguard-Op1=1, onguard-Op2=0, onguard-Op3=0, onguard-Op4=0, blacklisted-Op1=0, blacklisted-Op2=0, blacklisted-Op3=0, blacklisted-Op4=0, rec=−0.01, end=0].

Notification message Notif sent by the entity EM to G4: Observation: [request from Op1 to Op4=0, request from Op2 to Op4=0, request from Op3 to Op4=0, offer from Op1 to Op4=0, offer from Op2 to Op4=0, offer from Op3 to Op4=0, onguard-Op1=1, onguard-Op2=0, onguard-Op3=0, onguard-Op4=0, blacklisted-Op1=0, blacklisted-Op2=0, blacklisted-Op3=0, blacklisted-Op4=0, rec=−0.01, end=0].

The notification messages can further comprise information indicating whether one or more operators receiving the notification message is removed from the method, i.e., placed on a blacklist, thus indicating which operators cannot participate in the substitution method. An operator can be placed on a blacklist when, for example, it does not route the data from the other operators even though the method has finished and it has been determined that it was the active operator. This information concerning a removed operator can be supplemented by information relating to the duration over which the operator is removed.

According to one example, the notification messages can further comprise a datum relating to the consumption of resources saved during the next period of inactivity. This datum can be an estimated resource that can be modified by the actual consumption information transmitted by means of a registration entity, for example.

During step E6, the management entities G1, G2, G3 and G4 send a new request message Req since the state value (end) was 0 in the notification messages received during step E5.

These request messages assume the following form:

Request message Req sent by the entity G1 to the entity EM: Action: [request from Op1 to Op2=0, request from Op1 to Op3=0, request from Op1 to Op4=0, offer from Op1 to Op2=1, offer from Op1 to Op3=1, offer from Op1 to Op4=1, agent-id=1].

Request message Req sent by the entity G2 to the entity EM: Action: [request from Op2 to Op1=0, request from Op2 to Op3=0, request from Op2 to Op4=0, offer from Op2 to Op1=0, offer from Op2 to Op3=0, offer from Op2 to Op4=0, agent-id=2].

Request message Req sent by the entity G3 to the entity EM: Action: [request from Op3 to Op1=0, request from Op3 to Op2=0, request from Op3 to Op4=0, offer from Op3 to Op1=0, offer from Op3 to Op2=0, offer from Op3 to Op4=0, agent-id=3].

Request message Req sent by the entity G4 to the entity EM: Action: [request from Op4 to Op1=0, request from Op4 to Op2=0, request from Op4 to Op3=0, offer from Op4 to Op1=0, offer from Op4 to Op2=0, offer from Op4 to Op3=0, agent-id=4].

These request messages indicate that the management entity G1 offers a substitution service to the other three operators, via the information present in the interaction parameter of the message Req sent by the management entity G1.

Upon receipt of these request messages, the mediation entity EM then proceeds in step E7 in accordance with step E4, and updates the interaction parameters of the notification messages to be sent to the management entities as a function of the information present in the interaction parameters of the request messages Req.

During step E8, the mediation entity EM sends new notification messages to the management entities G1, G2, G3. G4. These messages assume the following format:

Notification message Notif sent by the entity EM to G1: Observation: [request from Op2 to Op1=0, request from Op3 to Op1=0, request from Op4 to Op1=0, offer from Op2 to Op1=0, offer from Op3 to Op1=0, offer from Op4 to Op1=0, onguard-Op1=1, onguard-Op2=0, onguard-Op3=0, onguard-Op4=0, blacklisted-Op1=0, blacklisted-Op2=0, blacklisted-Op3=0, blacklisted-Op4=0, rec=−1.00, end=1].

Notification message Notif sent by the entity EM to G2: Observation: [request from Op1 to Op2=0, request from Op3 to Op2=0, request from Op4 to Op2=0, offer from Op1 to Op2=1, offer from Op3 to Op2=0, offer from Op4 to Op2=0, onguard-Op1=1, onguard-Op2=0, onguard-Op3=0, onguard-Op4=0, blacklisted-Op1=0, blacklisted-Op2=0, blacklisted-Op3=0, blacklisted-Op4=0, rec=0.00, end=1].

Notification message Notif sent by the entity EM to G3: Observation: [request from Op1 to Op3=0, request from Op2 to Op3=0, request from Op4 to Op3=0, offer from Op 1 to Op3=1, offer from Op2 to Op3=0, offer from Op4 to Op3=0, onguard-Op1=1, onguard-Op2=0, onguard-Op3=0, onguard-Op4=0, blacklisted-Op1=0, blacklisted-Op2=0, blacklisted-Op3=0, blacklisted-Op4=0, rec=0.00, end=1].

Notification message Notif sent by the entity EM to G4: Observation: [request from Op1 to Op4=0, request from Op2 to Op4=0, request from Op3 to Op4=0, offer from Op1 to Op4=1, offer from Op2 to Op4=0, offer from Op3 to Op4=0, onguard-Op1=1, onguard-Op2=0, onguard-Op3=0, onguard-Op4=0, blacklisted-Op1=0, blacklisted-Op2=0, blacklisted-Op3=0, blacklisted-Op4=0, rec=0.00, end=1].

These notification messages notify the management entities G2, G3 and G4 that the operator Op1, via its management entity G1, accepts their substitution requests and the operator Op1 agrees to route the data during the next substitution phase.

The remuneration or compensation value rec is set to 0.00 in the notification messages sent to the management entities G2, G3, G4 because the operators Op2, Op3 and Op4 see their traffic routed by the operator Op1, while the value of rec for the operator Op1 is set to −1.00 because this operator provides the routing for the other operators. The remuneration value set to 0.00 indicates that the operators will be substituted with another operator and the value −1.00 indicates that the operator in question provides routing for other operators. This value, indicating an amount of saved resources, advantageously can be used to determine the next active operator, with the operator that has received a value set to −1.00 having less likelihood of being determined than an operator that has received a value of 0.00.

The state value (end) of the notification messages is set to 1, indicating that the substitution method has allowed a substitution to be made between the operators following these negotiation exchanges of steps E1 to E8.

It should be noted that if no agreement is finalized while a configurable number n of notification messages has been sent to the management entities, then the state value is also set to 1, but without a substitution being able to be implemented due to a lack of agreement during the negotiation. In the event that the number n of messages is reached, according to one example and advantageously, the management entity EM feeds back not only end=1, but also rec=0.9 to notify the management entity Gi (in this case i ranges from 1 to 4) that it will not benefit from an offer for the next substitution. Thus, if the Gi use reinforcement learning, this allows their learning algorithm to be guided by showing them that a negotiation that has failed will cost them in terms of resources, since they will have to keep their network active during the next substitution or the next substitution cycle.

The mediation entity then updates the values, for example, the accumulated values, of the savings in resources of the various operators and the operator that caused the least amount of resources to be saved, i.e., that contributed the least to the substitution phases that were actually implemented, is determined during a step E9 as being an active operator for the next substitution phase. The identifier of this operator determined as being active will then be sent in an information message in accordance with step E1. Thus, the successive determined operators are those who contributed the least, ensuring that a method is provided whereby the operators are encouraged to contribute to the substitution phases in order to be able to save resources.

According to an alternative, and once the substitution has been made, during a step E10, the management entities (and notably the management entity of the active operator) can send a registration entity EE the resources that were actually consumed during the substitution phase. If the resources are watts-hours, the watt-hour count on the mediation entity advantageously can be updated with data originating from other stakeholders, for example, a Distributed Ledger Technology (DLT) of the registration entity that indicates the watt-hours actually used for maintaining the service and the associated infrastructure by virtue of the information sent by the management entities, for example. Indeed, there can be a difference between the pre-configured number of hours on which the mediation entity is based for its rolling fairness forecasts for the “turn” (operator responsible for the routing) and the number of watts-hours consumed a posteriori. Based on the consumption actually consumed by the operator completing a turn, the mediation entity, via the information relating to the resources that are actually consumed and sent by the registration entity during a step E11, simply updates the total energy used by the active operator in its table of accounts, thus allowing it to have an average per night for each active operator during successive substitution phases, thus improving the determination of the active operator for the next phase.

The substitution method and the corresponding determination method can be implemented on an actual network infrastructure or even can be implemented during a simulation, notably in order to show stakeholders (operators, service providers, etc.) that the method allows them to save resources and thus encourage them to deploy this type of method on existing infrastructures.

The substitution method is even more advantageous for each management entity of the plurality of management entities if all the management entities actively contribute to the method and, for example, comply with their role of active operator when they are designated as such by the mediation entity.

Furthermore, it should be noted that for greater efficiency and faster convergence of this multi-service provider cooperation corresponding to a MARL (Multi-Agent Reinforcement Learning) technique, it is more advantageous for the messages (information, request, notification) to include parameters and data coded with discrete values and more specifically with Boolean flags that make it possible for the management entities not to have too many different values to be tested during the initial phase of learning the most optimal exchanges, since the solution is found more quickly in this way.

The method also can be based on known techniques relating to social dilemmas such as the “prisoner's dilemma”. The remuneration values actually can be used as coefficients, namely R (Remuneration since the two cooperate), T (Temptation to not cooperate), S (Being taken advantage of since one entity cooperates but the other does not), P (Punishment since no one cooperates) of a social dilemma that is a prisoner's dilemma if T>R>P>S. The condition R>(S+T)/2 is necessary so that the prisoner's dilemma, when it is repeated, can emerge from the cooperation between the management entities. The remuneration values therefore advantageously can be used in the method implemented on the basis of the prisoner's dilemma so that the cooperative balance of the management entities, and therefore the convergence based on the actual contribution of each management entity to the method, is faster.

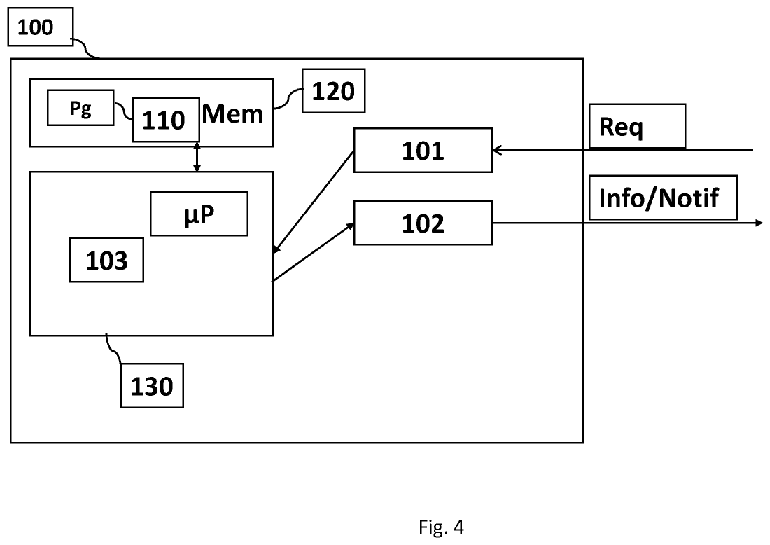

Reference will now be made to FIG. 4, which shows a substitution device 100 according to one embodiment of the invention.

Such a substitution device can be implemented in a mediation entity, such as the mediation entity EM shown in FIG. 2 and FIG. 3. This substitution device thus can be operated by an entity for regulating a communication service, or even by one of the service providers, which can be, according to one example, a network operator on which communication data relating to a digital service are routed.

For example, the substitution device 100 comprises a processing unit 130, equipped, for example, with a microprocessor AP, and controlled by a computer program 110, stored in a memory 120 and implementing the substitution method according to the invention. On initialization, the code instructions of the computer program 110 are loaded, for example, into a RAM memory, before being executed by the processor of the processing unit 130. Such a substitution device 100 comprises:
a transmitter 102,
able to send an information message Info to each management entity comprising an identifier of the active service provider and an interaction parameter between each service provider of the plurality of service providers; and
able to send, as long as a received state value does not indicate an end of negotiation, each management entity a notification message Notif comprising an identifier of the determined active service provider, the interaction parameter between each of the service providers updated as a function of the received request messages, a remuneration value of the service provider receiving the notification message, and the state value updated as a function of the interaction parameter of the notification message;
a receiver 101, able to receive, as long as the received state value does not indicate an end of negotiation, a request message Req from each management entity comprising an identifier of the service provider whose management entity sends the message and the interaction parameter updated as a function of the received information message or notification message;
a computer 103, able to update the state value as a function of the interaction parameter of the notification message.

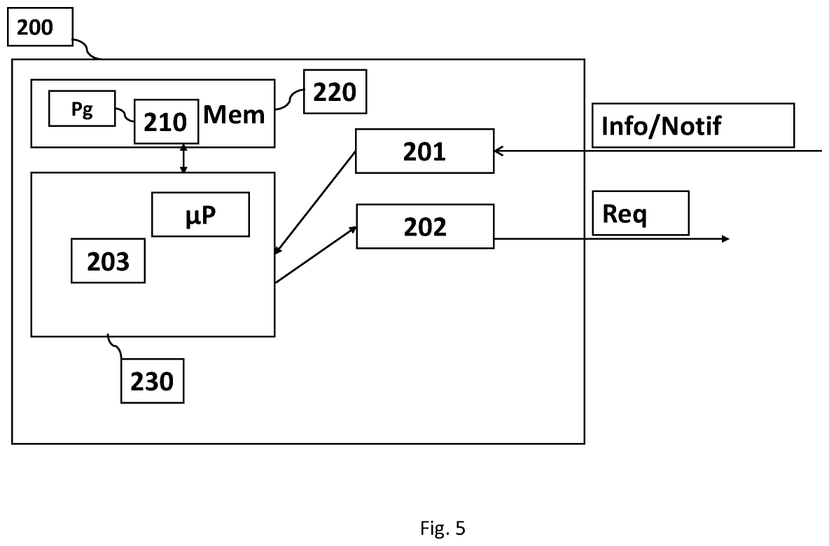

Reference will now be made to FIG. 5, which shows a determination device 200 according to one embodiment of the invention.

Such a determination device can be implemented in a management entity, such as the management entity G1, G2, G3, G4 shown in FIG. 2 and FIG. 3. This substitution device thus can be operated by a service provider such as an operator and can be, for example, instantiated in an administration entity of an operator network or of a communication service.

For example, the determination device 200 comprises a processing unit 230, equipped, for example, with a microprocessor μP, and controlled by a computer program 210, stored in a memory 220 and implementing the configuration method according to the invention. On initialization, the code instructions of the computer program 210 are loaded, for example, into a RAM memory, before being executed by the processor of the processing unit 230. Such a determination device 200 comprises:
a receiver 201,
able to receive an information message Info from the mediation entity comprising an identifier of the active service provider and an interaction parameter between each service provider of the plurality of service providers, and, as long as a state value does not indicate an end of negotiation:
able to receive at least one notification message Notif from the mediation entity comprising an identifier of the determined active service provider, the interaction parameter between each of the service providers updated as a function of the received request messages, a remuneration value of the service provider receiving the notification message, and the state value updated as a function of the interaction parameter of the notification message;
a computer 203, able to update the interaction parameter as a function of the received information message or notification message;
a transmitter 202, able to send the mediation entity at least one substitution request message Req comprising an identifier of the service provider whose management entity sends the message and the updated interaction parameter.

1. A substitution method comprising:
substituting a plurality of service providers with one of the service providers, called active service provider, of the plurality of service providers for the purpose of routing communication data, the substituting being implemented in a mediation entity able to communicate with a management entity implemented by each service provider of the plurality of service providers and comprising:
sending each management entity an information message comprising an identifier of the active service provider and an interaction parameter between each of the service providers of the plurality of service providers, and, as long as a state value is not set to indicate that one of the service providers of the plurality of service providers is in a position to route the data instead of the other service providers of the plurality of service providers:
at least one reception step of receiving a substitution request message from each management entity comprising an identifier of the service provider whose management entity sends the message and the interaction parameter updated as a function of the received information message or notification message; and
at least one sending step of sending each management entity a notification message comprising an identifier of the determined active service provider able to substitute for the operators of the plurality of operators for routing data, the interaction parameter between each of the service providers updated as a function of the received request messages, a remuneration value of the service provider the notification message indicating the contribution of the service provider to data routing over previous periods, and the state value updated by the management entity as a function of the interaction parameter of the notification message.

2. The substitution method as claimed in claim 1, wherein the interaction parameter between each of the service providers of the plurality of service providers comprises:
a parameter requesting the substitution of one service provider of the plurality service providers for each of the other service providers of the plurality of service providers;
a parameter offering the substitution of one service provider of the plurality of service providers for each of the other service providers of the plurality of service providers.

3. The substitution method as claimed in claim 21, wherein updating the interaction parameter as a function of the received request messages comprises configuring, in the notification message sent to the management entity of the active service provider, substitution requests received in the request messages sent by the non-active service providers of the plurality of service providers.

4. The substitution method as claimed in claim 1, wherein the updated interaction parameter of the request message further comprises a datum relating to the technology of a communication network of the service provider whose management entity sends the request message.

5. The substitution method as claimed in claim 1, wherein the notification message further comprises information indicating whether the service provider whose management entity receives the notification message is removed from the plurality of service providers when implementing the substitution method.

6. The substitution method as claimed in claim 1, wherein the notification message further comprises a datum related to the consumption of resources saved by substituting the service providers of the plurality of service providers with the active service provider.

7. The substitution method as claimed in claim 1, wherein the state value is set to indicate that one of the service providers of the plurality of service providers is in a position to route the data instead of the other service providers of the plurality of service providers if the interaction parameter of the request message sent by the active service provider comprises a substitution offer parameter or if the number of request and/or notification messages reaches a predetermined value.

8. The substitution method as claimed in claim 1, wherein the remuneration value relates to the savings in resources generated by the recipient service provider.

9. The substitution method as claimed in claim 1, wherein a new active service provider is also determined as a function of the transmitted remuneration values and/or as a function of a resource consumed by the active service provider for routing communication data as a substitute for the service providers of the plurality of service providers.

10. A determination method comprising:
determining an active service provider from among a plurality of service providers for the purpose of routing communication data, the determining being implemented by a management entity of each service provider of the plurality of service providers that is able to communicate with a mediation entity and comprising:
receiving an information message from the mediation entity comprising an identifier of the active service provider and an interaction parameter between each of the service providers of the plurality of service providers, and, as long as a state value is not set to indicate that one of the service providers of the plurality of service providers is in a position to route the data instead of the other service providers of the plurality of service providers:
at least one updating step for updating the interaction parameter as a function of the received information message or notification message;
at least one sending step for sending the mediation entity a substitution request message comprising an identifier of the service provider whose management entity sends the message and the updated interaction parameter; and
at least one reception step for receiving a notification message from the mediation entity comprising an identifier of the determined active service provider, able to substitute for the operators of the plurality of operators for routing data, the interaction parameter between each of the service providers updated as a function of the received request messages, a remuneration value of the service provider receiving the notification message indicating the contribution of the service provider to data routing over previous periods, and the state value updated by the management entity as a function of the interaction parameter of the notification message.

11. The determination method as claimed in claim 10, wherein updating the interaction parameter in the request messages comprises updating a parameter requesting the substitution of a non-active service provider of the plurality of service providers for the active service provider as a function of the identifier of the active service provider received in the notification message or the offer for substitution by the active service provider to the non-active service providers as a function of the request parameters received in the notification messages.

12. The determination method as claimed in claim 10, further comprising the management entity of the active service provider sending a registration entity a resource consumed for routing the communication data in substitution for the service providers of the plurality of service providers.

13. A device for substituting a plurality of service providers with one of the service providers, called active service provider, of the plurality of service providers for the purpose of routing communication data, the device being implemented in a mediation entity able to communicate with a management entity implemented by each service provider of the plurality of service providers and comprising:
a transmitter,
configured to send an information message to each management entity comprising an identifier of the active service provider and an interaction parameter between each of the service providers of the plurality of service providers; and
configured to send, as long as a received state value is not set to indicate that one of the service providers of the plurality of service providers is in a position to route the data instead of other service providers of the plurality of service providers, each management entity a notification message comprising an identifier of the determined active service provider, able to substitute for the operators of the plurality of operators for routing data, the interaction parameter between each of the service providers updated as a function of the received request messages, a remuneration value of the service provider receiving the notification message indicating the contribution of the service provider to data routing over previous periods, and the state value updated as a function of the interaction parameter of the notification message;
a receiver, configured to receive, as long as the received state value is not set to indicate that one of the service providers of the plurality of service providers is in a position to route data instead of the other service providers of the plurality of service providers, a substitute request message from each management entity comprising an identifier of the service provider whose management entity sends the message and the interaction parameter updated as a function of the received information message or notification message; and
a computer, configured to update the state value as a function of the interaction parameter of the notification message.

14. A device for determining an active service provider from among a plurality of service providers for the purpose of routing communication data, the device being implemented in a management entity of each service provider of the plurality of service providers that is able to communicate with a mediation entity and comprising:
a receiver,
configured to receive an information message from the mediation entity comprising an identifier of the active service provider and an interaction parameter between each of the service providers of the plurality of service providers, and, as long as a received state value is not set to indicate that one of the service providers of the plurality of service providers is in a position to route the data instead of the other service providers of the plurality of service providers:
configured to receive at least one notification message from the mediation entity comprising an identifier of the determined active service provider, able to substitute for the operators of the plurality of operators for routing data, the interaction parameter between each of the service providers updated as a function of the received request messages, a remuneration value of the service provider receiving the notification message indicating the contribution of the service provider to data routing over previous periods, and the state value updated as a function of the interaction parameter of the notification message;
a computer, configured to update the interaction parameter as a function of the received information message or notification message; and
a transmitter, configured to send the mediation entity at least one substitution request message comprising an identifier of the service provider whose management entity sends the request message and the updated interaction parameter.

15. (canceled)

16. A non-transitory computer readable medium comprising instructions of a computer program stored thereon for implementing a substitution method when the instructions are executed by a processor of a mediation entity, wherein the substitution method comprises:
substituting a plurality of service providers with one of the service providers, called active service provider, of the plurality of service providers for the purpose of routing communication data, the mediation entity being able to communicate with a management entity implemented by each service provider of the plurality of service providers, wherein the substituting comprises:
sending each management entity an information message comprising an identifier of the active service provider and an interaction parameter between each of the service providers of the plurality of service providers, and, as long as a state value is not set to indicate that one of the service providers of the plurality of service providers is in a position to route the data instead of the other service providers of the plurality of service providers:
at least one reception step of receiving a substitution request message from each management entity comprising an identifier of the service provider whose management entity sends the message and the interaction parameter updated as a function of the received information message or notification message; and
at least one sending step of sending each management entity a notification message comprising an identifier of the determined active service provider able to substitute for the operators of the plurality of operators for routing data, the interaction parameter between each of the service providers updated as a function of the received request messages, a remuneration value of the service provider the notification message indicating the contribution of the service provider to data routing over previous periods, and the state value updated by the management entity as a function of the interaction parameter of the notification message.
